(19) United States
(12) Patent Application Publication
(10) Pub. No.: US 2008/0272905 A1
(43) Pub. Date: Nov. 6, 2008

(54) Attendance Management System

(75) Inventors: Nobutoshi Higaki, Kanagawa (JP); Masahiko Tamura, Kanagawa (JP); Tamihiro Izumi, Kanagawa (JP); Kazumi Endo, Tokyo (JP); Osamu Kato, Kanagawa (JP); Akihiro Oyama, Hyogo (JP)

Correspondence Address: DICKINSON WRIGHT PLLC, 1901 L STREET NW, SUITE 800, WASHINGTON, DC, 20036, US

(73) Assignee: Matsushita Electric Industrial Co., Ltd., Osaka (JP)

(21) Appl. No.: 11/578,355

(22) PCT Filed: Mar. 31, 2005
(86) PCT No.: PCT/JP05/06257

§ 371 Date: Nov. 17, 2006

(51) Int. Cl. G08B 1/08

(52) U.S. Cl. 340/539.11

(57) ABSTRACT

There is provided an attendance management system capable of easily checking attendance without requiring a special procedure or an individual authentication card or an attendance permission card. The attendance management system (100) includes a desk (103) having an identifier which can be imaged, a mobile telephone (102) having the camera function, and a center device (101) for checking attendance according to the identifier of the desk (103) and an identifier of the mobile telephone (102) transmitted from the mobile telephone (102). According to the identifier of the desk and the identifier of the mobile telephone, it is possible to check which student (mobile telephone) is present at which lesson (desk). Thus, it is possible to easily check attendance.

### TECHNICAL FIELD

The present invention relates to a technology for confirming attendance electronically without the need for a roll call, etc.

### BACKGROUND ART

Conventionally, in, for example, a lecture at a university, it is necessary for an instructor to take a roll call every lecture. This is extremely time-consuming and reduces the time of the lecture.

Taking this into consideration, apparatuses for electronically confirming attendance have been proposed (for example, refer to Patent Documents 1 and 2). With this type of attendance management apparatuses, a name of an attendee or code decided in advance is selected and recorded using, for example, a keyboard or mouse of a computer. An administrator then confirms the person and registers this person in the attendance apparatus.

### Patent Document 1: Japanese Patent Application Laid-open No. 2002-261969.

### Patent Document 2: Japanese Patent Application Laid-open No. 2002-366995.

### DISCLOSURE OF INVENTION

### Problems to be Solved by the Invention

However, with the conventional attendance management apparatus, it is necessary to carry some kind of printed matter on which individual information is printed with a barcode or electronic media storing individual information to read into the attendance management apparatus. This means that a dedicated apparatus is required for every lecture room, and it costs a lot of money to incorporate the systems into all lecture rooms.

Further, consideration is not given to attendance by people who are not qualified to attend, attendance confirmation by proxy, attendance midway through after attendance confirmation is carried out, or walkout midway through after attendance confirmation is carried out.

It is therefore an object of the present invention to provide an attendance management system where attendance confirmation can be carried out easily without requiring a special procedure, individual authentication card, or attendance permission card.

### Means for Solving the Problem

In order to solve these problems, the present invention is provided with a desk that has photographable identification information, a mobile telephone with a camera function, and a center apparatus that carries out attendance confirmation based on identification information of a desk and identification information of a mobile telephone transmitted from the mobile telephone. In this way, at the center apparatus, it is possible to confirm which student (mobile telephone) is attending which lecture (desk) from the identification information of the desk and the identification information of the mobile telephone, thereby carrying out attendance confirmation easily.

### ADVANTAGEOUS EFFECT OF THE INVENTION

According to the present invention, it is possible to implement an attendance management system where attendance confirmation can be easily carried out without requiring a special procedure, individual authentication card, or attendance permission card.

### BRIEF DESCRIPTION OF THE DRAWINGS

FIG. 1 shows a configuration for an attendance management system of an embodiment of the present invention;

FIG. 2 is a block diagram showing an example of a configuration of a center apparatus;

FIG. 3 is a block diagram showing an example of a configuration of a mobile telephone apparatus;

FIG. 4 is a flowchart illustrating a description of the operations of an embodiment;

FIG. 5 shows an example display of an attendance status of an embodiment;

FIG. 6 shows a configuration of an attendance management system of another embodiment; and

FIG. 7 is a flowchart illustrating the operations of the attendance management system of FIG. 6.

### BEST MODE FOR CARRYING OUT THE INVENTION

Embodiments of the present invention will be explained below in detail with reference to the accompanying drawings.

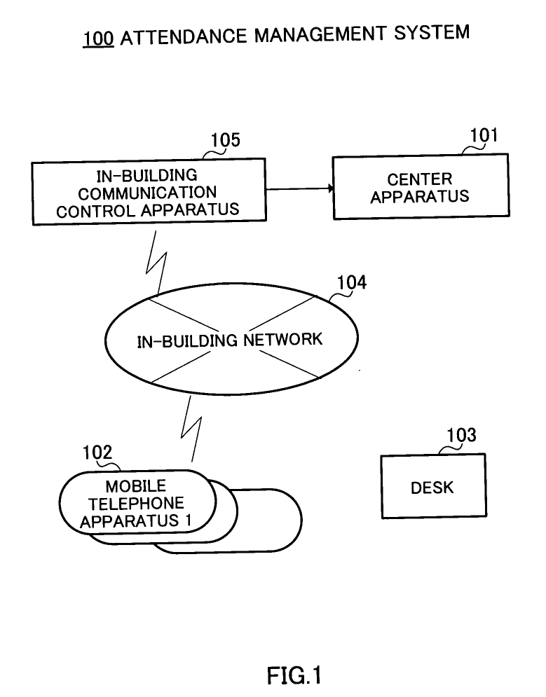

FIG. 1 shows an overall configuration for an attendance management system of this embodiment. Attendance management system 100 has: center apparatus 101 used by an instructor; mobile telephone apparatus 102 used by a student; desk 103 having an identifiable ID (identification information); in-building network 104 used in mobile telephone communication; and in-building communication control apparatus 105 connecting in-building network 104 and center apparatus 101.

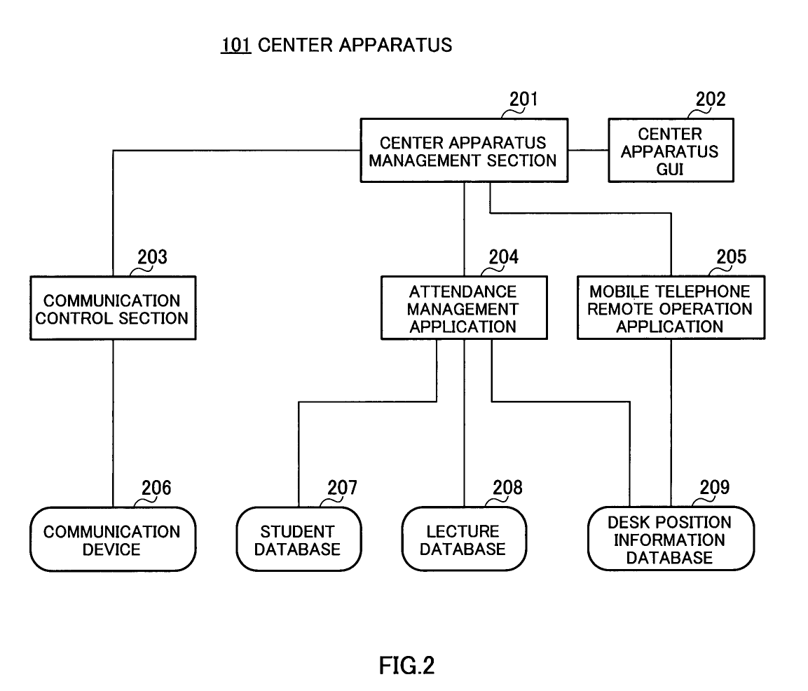

FIG. 2 shows an example of a detailed configuration of center apparatus 101. Center apparatus 101 has: center apparatus management section 201 that manages the whole center apparatus; center apparatus GUI 202 that transmits an instruction from an instructor to center apparatus management section 201; communication control section 203 that controls communication with external in-building communication control apparatus 105 using communication device 206; attendance management application 204 that manages attendance; mobile telephone remote operation application 205 that is capable of operating mobile telephone apparatus 102 of a student from the side of center apparatus 101; student database 207 that has a student ID, an ID of mobile telephone apparatus 102 of each student, and an ID of a lecture taken by each student and is capable of recording an ID of a lecture a student attends; lecture database 208 that has information of a lecture ID given to the lecture, start and end time of the lecture and a lecture room where the lecture is held and is capable of recording an ID of the attending students; and desk position information database 209 that has a desk ID and a lecture room where the desk is located and a position of the desk within the lecture room and is capable of recording current occupancy information of the desk and an ID of the student who occupies the desk.

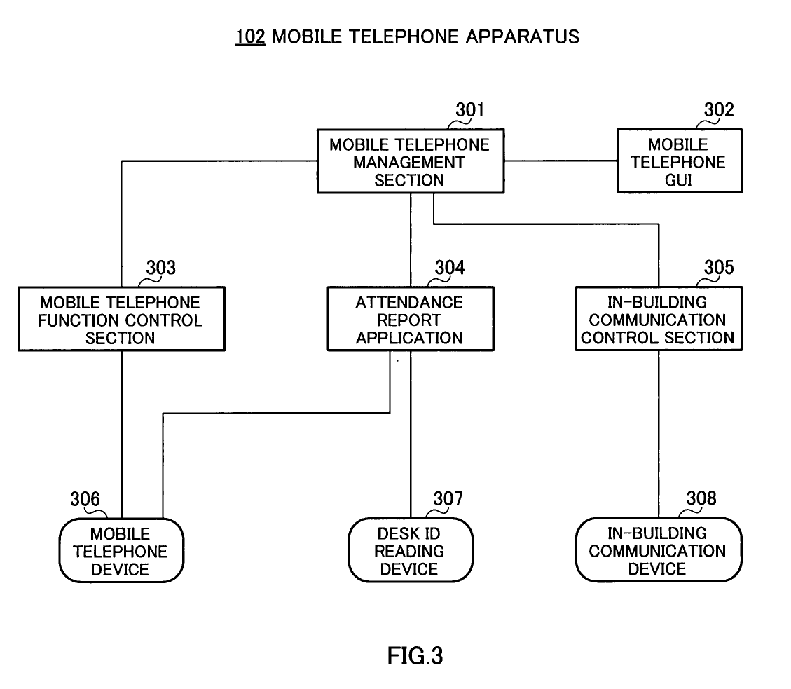

FIG. 3 shows an example of a detailed configuration for mobile telephone apparatus 102. Mobile telephone apparatus 102 has: mobile telephone management section 301 that manages mobile telephones; mobile telephone GUI 302 that transmits an instruction from a user to mobile telephone management section 301; mobile telephone function control section 303 that manages a mobile telephone function using mobile telephone device 306; desk ID reading device 307 that reads a desk ID; attendance report application 304 that reports the read desk ID; and in-building communication control section 305 that manages in-building communication using in-building communication device 308.

Next, the operations at the time of attendance confirmation will be described using FIG. 1, FIG. 2 and FIG. 3. An example will be described where wireless LAN network is taken as in-building network 104, a telephone number of a mobile telephone is taken as the ID of mobile telephone apparatus 102, and a barcode is taken as the ID of desk 103.

When attendance confirmation is carried out, a student activates attendance report application 304 via mobile telephone management section 301 using mobile telephone GUI 302 of mobile telephone apparatus 102 within the lecture room where the lecture is being held.

The activated attendance report application 304 then recognizes the ID of desk 103 using desk ID reading device 307 and, acquires an ID (telephone number) of the mobile telephone from mobile telephone device 306.

Attendance report application 304 then sends the acquired ID of desk 103 and ID of mobile telephone apparatus 102 to in-building communication control apparatus 105 via in-building network (wireless LAN network) 104 using in-building communication control section 305 as one set of data taken as a attendance report.

In-building communication control apparatus 105 then assigns an ESSID (Extended Service Set ID) of a wireless LAN used in in-building communication to the transmitted data of the ID of desk 103 and the ID of mobile telephone apparatus 102, and transmits the result to center apparatus 101.

Center apparatus 101 receives the transmitted data of the ID of desk 103, the ID of mobile telephone apparatus 102, and the ESSID at communication control section 203 using communication device 206, and if the ESSID is transmitted from the in-building wireless LAN, the data of the ID of desk 103 and the ID of the mobile telephone is transmitted to attendance management application 204.

Communication control section 203 discards the data if the ESSID is not from the in-building wireless LAN. By this means, attendance confirmation by sending data from external network is impossible, so that it is possible to prevent fraudulent attendance.

Attendance management application 204 searches desk position information database 209 so as to acquire the lecture room where the desk is located and position information of the desk within the lecture room from the received ID of desk 103 and the ID of mobile telephone apparatus 102, and searches lecture database 208 so as to acquire lecture ID1 from the acquired lecture room and current time. On the other hand, attendance management application 204 searches student database 207 so as to acquire ID2 of the lecture to be taken from the ID of mobile telephone apparatus 102 and current time.

If the lecture ID1 acquired from the ID of desk 103 and the ID2 acquired from the ID of mobile telephone apparatus 102 match, attendance management application 204 determines that the student is attending a lecture to attend, adds a lecture attendance ID to student database 207, changes the occupancy state of desk position information database 209 to normal, registers the ID of the occupying student, and adds the student ID to lecture database 208.

On the other hand, if the ID of mobile telephone apparatus 102 does not exist, or if the lecture room information acquired from the ID of mobile telephone apparatus 102 and the lecture room ID acquired from the ID of the desk do not match, the occupancy state of desk position information database 209 is regarded to be abnormal.

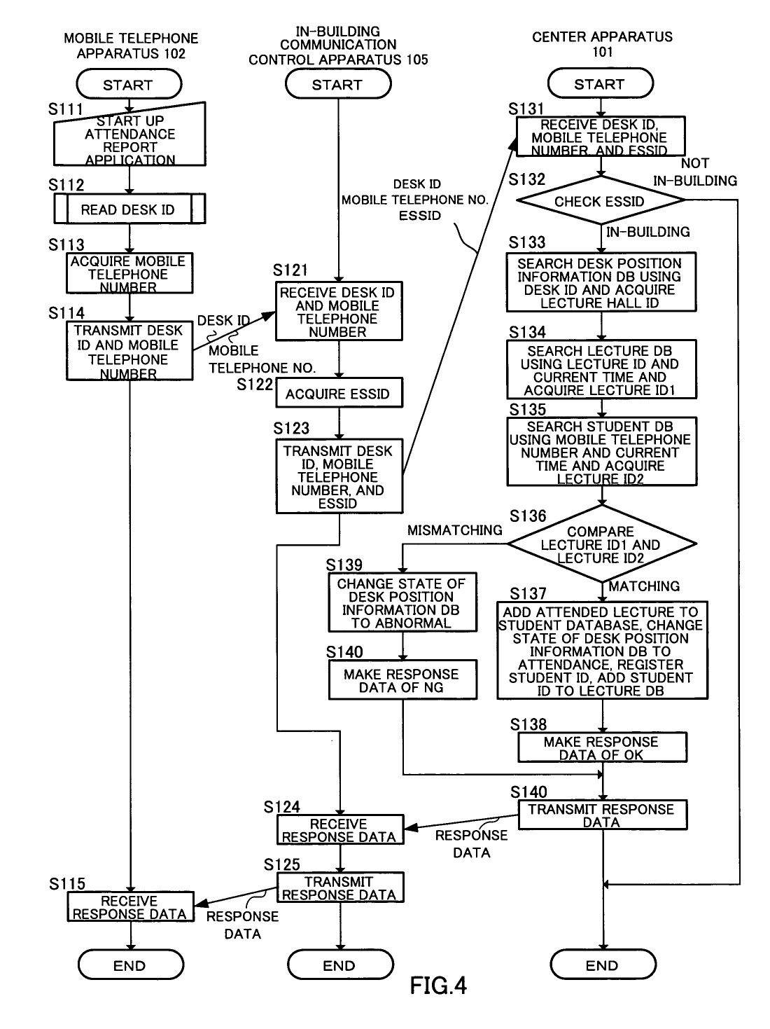

The overall operations of this embodiment will be described using FIG. 4.

Mobile telephone apparatus 102 first activates attendance report application 304 (S111), reads a barcode provided at desk 103 by desk ID reading device 307 (S112) acquires a mobile telephone number from mobile telephone device 306 (S113), then transmits the desk ID and mobile telephone number using in-building communication control section 305 and in-building communication device 308 (S114).

After receiving the desk ID and mobile telephone number (S121), in-building communication control apparatus 105 acquires an ESSID of the wireless LAN used in the in-building communication from in-building network 104 (S122), and transmits the desk ID, mobile telephone number and ESSID to center apparatus 101 (S123).

After receiving the desk ID, mobile telephone number and ESSID (S131), center apparatus 101 checks the ESSID (S132), and if this is not an in-building ESSID, the processing ends, and if this is an in-building ESSID, a lecture room ID is acquired by searching desk position information database 209 using the received desk ID (S133). Next, center apparatus 101 acquires lecture ID1 by searching lecture database 208 using the lecture room ID and current time (S134), and acquires lecture ID2 by searching student database 207 using the mobile telephone number and current time (S135).

Next, center apparatus 101 compares lecture ID1 and lecture ID2 (S136), and in the case of mismatching, center apparatus 101 changes the state of desk position information database 209 to be abnormal (S139), and produces NG data (S140). In contrast, in the case where lecture ID1 and lecture ID2 match, center apparatus 101 adds a lecture attendance ID to student database 207, registers the student ID with the state of the desk position information database changed to be occupied, and adds the student ID to lecture database 208 (S137). Response data of OK is then produced (S138). Center apparatus 101 then transmits the response data in step S140.

Upon receiving the response data (S124), in-building communication control apparatus 105 transmits this data to mobile telephone apparatus 102 (S125), and mobile telephone apparatus 102 receives this response data (S115). By this means, the user of mobile telephone apparatus 102 is able to know whether or not attendance of the user has been verified.

According to this embodiment, by providing desk 103 that has photographable identification information, mobile telephone apparatus 102 with a camera function, and center apparatus 101 that carries out attendance confirmation based on identification information of desk 103 and identification information of mobile telephone apparatus 102 transmitted from mobile telephone apparatus 102, it is possible to confirm which student (mobile telephone) is taking which lecture (desk) from the identification information of the desk and the identification information of the mobile telephone, thereby implementing attendance management system 100 that is capable of carrying out attendance confirmation easily.

Further, center apparatus 101 confirms attendance based on a tag (ESSID) of the in-building network to which the mobile telephone is connected, in addition to the identification information of the desk and the identification information of the mobile telephone, so that it is possible to prevent fraudulent attendance by transmitting data from external network, and further improve reliability of attendance confirmation.

Further, center apparatus 101 is configured so as to have student database 207 that has identification information of a student, identification information of a mobile telephone of the student, and identification information of a lecture taken by the student, lecture database 208 that has the lecture identification information, start times and end times of the lecture, and information of a lecture room where the lecture is held, desk position information database 209 that has identification information of a desk and information of the lecture room where the desk is located and a position of the desk within the lecture room, and attendance management application 204 that acquires the lecture the student is attending and lectures to be taken by the student from the databases using the identification information of the desk and the identification information of the mobile telephone transmitted from the mobile telephone and confirms the attendance of the student by comparing these information, so that it is possible to carry out strict attendance confirmation based on the identification information of the desk and the identification information of the mobile telephone transmitted from the mobile telephone.

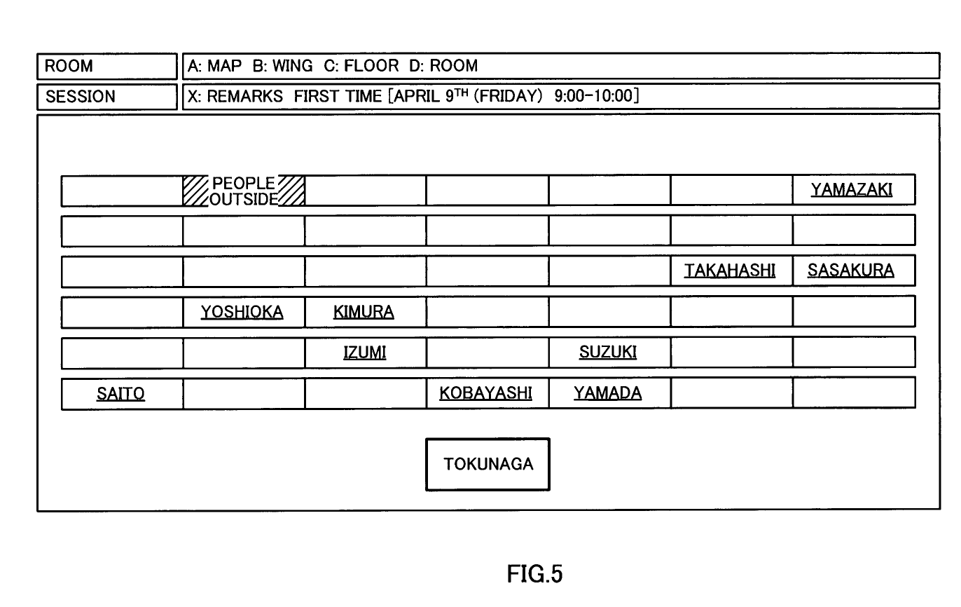

Further, according to this embodiment, an instructor is able to understand the attendance status at a glance by displaying the position information, occupancy state, and ID of the occupying student of desk 103 located within the lecture room of desk position information database 209 using center apparatus GUI 202 according to the arrangement of desk 103 within the lecture room. An display example is shown in FIG. 5.

The present invention is not limited to the above-described embodiment, and various modifications may be implemented as follows:

1) Although the case of using a wireless LAN as in-building network 104 has been described in the above-described embodiment, this is by no means limiting, and the same results can also be obtained even in the case of using in-building PHS network, in-building mobile telephone network, or in-building wired wiring.

2) Although the case has been described in the above-described embodiment where a telephone number of a mobile telephone is used as a mobile telephone ID, this is by no means limiting, and the same results can also be obtained in the case of using SIM information of a mobile telephone or a student ID registered in an IC card.

3) Although the case has been described in the above-described embodiment where a barcode is used as an ID of the desk 103, this is by no means limiting, and the same results can also be obtained in the case of using an RFID.

4) Although the case has been described in the above-described embodiment where a desk ID and a mobile telephone ID are transmitted to in-building communication control apparatus 105 using mobile telephone apparatus 102, in addition to this, data of a face shot taken of the student may also be transmitted. Moreover, by registering a photograph of the student in desk position information database 209 and displaying a face shot of the attending student when the instructor looks at desk position information database 209, it is also possible to prevent attendance confirmation by proxy.

5) In the case of transmitting face shot data as in 4), by registering the photograph data in student database 207 in advance, and determining whether or not this photograph data and the face shot given as an attendance report from mobile telephone apparatus 102 are identical by the image confirmation application of attendance management application 204, it is possible to reduce the time for the instructor to confirm the student.

6) In the case of transmitting the face shot data as in 4), by saving the face shot of the student transmitted at the time of attendance confirmation as history in student database 207, it is possible to meet changes of the face with the passage of time from the photograph at the time of initial registration in student database 207.

7) In the above-described embodiment, although the case has been described where mobile telephone apparatus 102 transmits a desk ID and mobile telephone ID to in-building communication control apparatus 105, in addition to this, it is also possible to prevent masquerading attendance using stored data by transmitting image that only exists in this lecture such as characters written on a blackboard and an OHP at the same time.

8) In 7), by calculating photographing distance and angle from position information of the desk specified at the time of attendance confirmation, and comparing image data such as comparing characters written on a blackboard and OHP at the time of the attendance report with a change state, it is possible to specify that this is data photographed from this desk, thereby implementing further reliable attendance management.

9) In 4) and 7), by taking image of the face of the student and image that only exists at the lecture such as characters written on a blackboard or OHP simultaneously, and synthesizing these into one item of data and sending this data to in-building communication control apparatus 105 using a mobile telephone having two cameras, it is possible to increase the precision of attendance confirmation and implement reliable attendance management.

10) In the above-described embodiment, an instructor uses center apparatus GUI 202 so as to activate mobile telephone remote operation application 205, and acquires the IDs of attending students in desk position information database 209, so that it is possible to limit reception and transmission of mobile telephones of the attending students and reception and transmission of e-mail.

11) In the above-described embodiment, an instructor activates mobile telephone remote operation application 205 using center apparatus GUI 202 and acquires the IDs of the attending students in desk position information database 209, so that it is possible to confirm students using the camera function of the mobile telephones of the attending students.

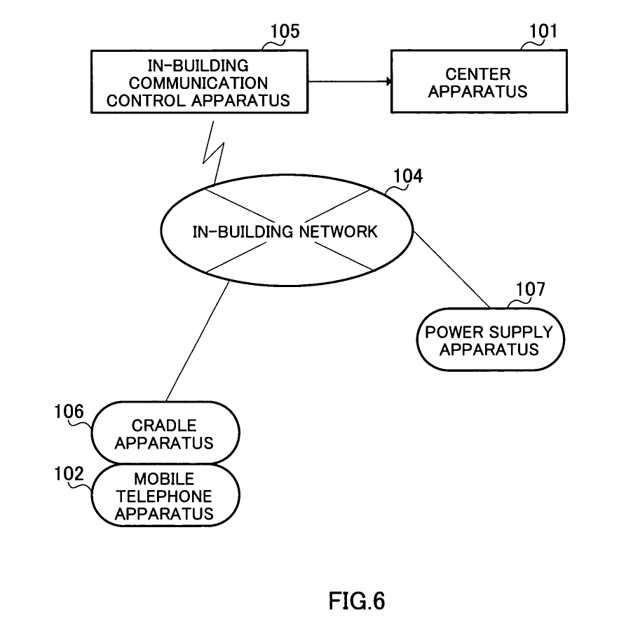

12) Although the case has been described in the above-described embodiment where desk 103 having an identifiable ID is provided, as shown in FIG. 6, a configuration where, instead of using desk 103 having the identifiable ID, cradle apparatus 106 having a unique ID capable of supplying electric power, and power supply apparatus 107 supplying electric power to cradle apparatus 106, connected to in-building network 104 may also be provided. With this configuration, it is possible to avoid a situation where operation of the attendance system is not possible due to the battery of a mobile telephone being dead. Further, by changing the ID of desk 103 described in this embodiment to a unique ID of cradle apparatus 106 and changing desk position information database 209 of center apparatus 101 to a cradle database, it is possible to obtain the same advantages in this embodiment.

13) In the configuration of 12), by providing a cradle state monitoring application that detects whether or not mobile telephone apparatus 102 is located at cradle apparatus 106 at in-building communication control apparatus 105, it is possible to carry out attendance confirmation that is the same as in the embodiment when mobile telephone apparatus 102 is positioned at cradle apparatus 106, and confirm walkout at the time that mobile telephone apparatus 102 goes away from cradle apparatus 106.

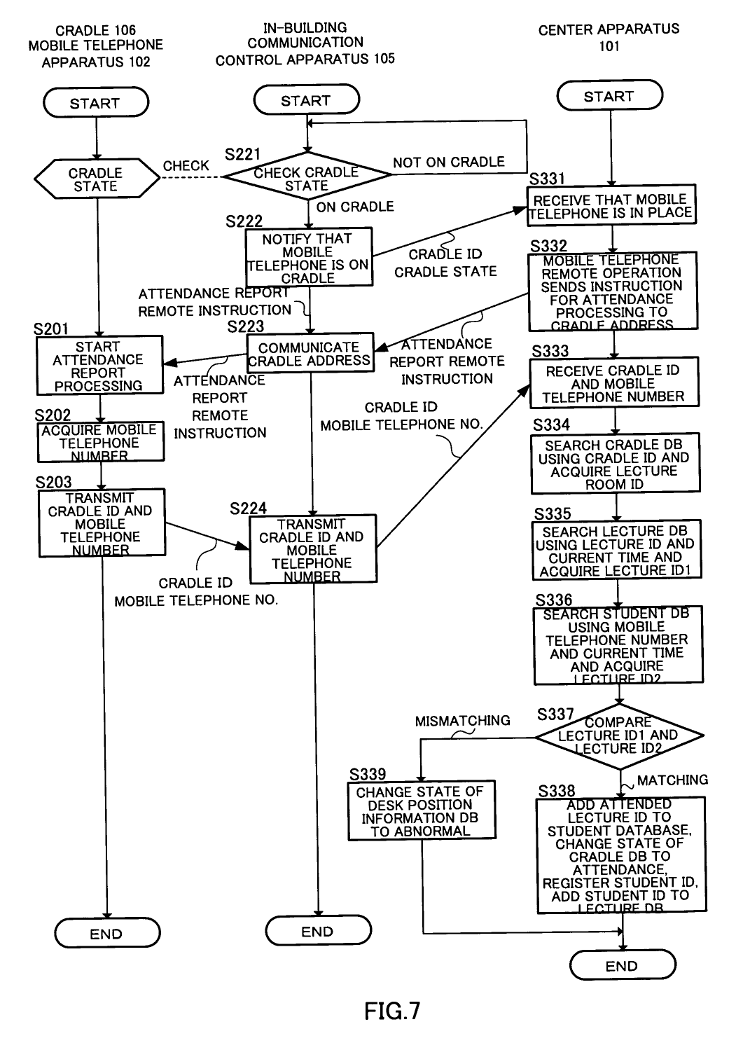

Here, the operations of the attendance management system of the configuration shown in FIG. 6 will be described using FIG. 7.

In-building communication control apparatus 105 first checks the state of cradle apparatus 106 (S221), and when mobile telephone apparatus 102 is determined to be laid on cradle apparatus 106, reports with the cradle ID to center apparatus 101 that mobile telephone apparatus 102 is laid on cradle apparatus 106 (S222).

Upon receiving information that mobile telephone apparatus 102 is positioned at cradle apparatus 106 (S331) center apparatus 101 transmits an instruction for attendance processing using a mobile telephone remote operation to cradle apparatus 106 (S332). This instruction is transmitted to cradle apparatus 106 via in-building communication control apparatus 105 (S223).

Upon receiving the attendance report remote instruction, cradle apparatus 106 starts attendance report processing (S201), acquires a mobile telephone number from mobile telephone apparatus 102 (S202), and transmits a cradle ID and mobile telephone number (S203). This cradle ID and mobile telephone number are transmitted to center apparatus 101 via in-building communication control apparatus 105 (S224).

Upon receiving the cradle ID and mobile telephone number (S333), center apparatus 101 first searches the cradle database using the cradle ID and acquires a lecture room ID (S334). Next, center apparatus 101 acquires lecture ID1 by searching lecture database using the lecture room ID and current time (S335), and acquires lecture ID2 by searching student database using the mobile telephone number and current time (S336).

Next, center apparatus 101 compares lecture ID1 and lecture ID2 (S337), and in the case of mismatching, center apparatus 101 changes the state of desk position information database to be abnormal (S339). In contrast, in the case where lecture ID1 and lecture ID2 match, center apparatus 101 adds a lecture attendance ID to student database, registers the student ID changing the state of the cradle database to attendance, and adds the student ID to lecture database (S338).

The present application is based on Japanese Patent Application No. 2004-118286 filed on Apr. 13, 2004, the entire content of which is expressly incorporated by reference herein.

### INDUSTRIAL APPLICABILITY

The present invention has an advantage of making it possible to confirm attendance without requiring special procedures, individual authentication cards or attendance permission cards, and is therefore suitable for application in the case of carrying out attendance confirmation of students in schools, for example.

1. An attendance management system comprising:
a desk that has photographable identification information;
a mobile telephone with a camera function; and
a center apparatus that carries out attendance confirmation based on identification information of the desk and identification information of the mobile telephone transmitted from the mobile telephone.

2. The attendance management system of claim 1, wherein the center apparatus confirms attendance based on a tag of in-building network to which the mobile telephone is connected, in addition to the identification information of the desk and the identification information of the mobile telephone.

3. The attendance management system of claim 1, wherein the center apparatus comprises:
a student database that has identification information of a student, identification information of a mobile telephone of the student, and identification information of a lecture taken by the student;
a lecture database that has identification information of a lecture, start times and end times of the lecture, and information of a lecture room where the lecture is held;
a desk position information database that has identification information of a desk, and information of a lecture room where the desk is located and a position of the desk within the lecture room; and
an attendance management application that acquires the lecture the student is attending and lectures to be taken by the student from the databases using the identification information of the desk and the identification information of the mobile telephone transmitted from the mobile telephone, and confirms attendance of the student by comparing these information.

4. The attendance management system of claim 1, wherein:
a face shot is transmitted from the mobile telephone in addition to the identification information of the desk and the identification information of the mobile telephone; and
the center apparatus that carries out attendance confirmation based on a pre-registered face shot of the student and the transmitted face shot in addition to the identification information of the desk and the identification information of the mobile telephone.

5. The attendance management system of claim 1, wherein, in addition to the identification information of the desk and the identification information of the mobile telephone, image of a lecture room is transmitted.

6. The attendance management system of claim 1, wherein the center apparatus further comprises a mobile telephone remote operation section that limits reception and transmission of the mobile telephone confirmed as in attendance.

7. The attendance management system of claim 1, further comprising a cradle to load the mobile telephone,
wherein the center apparatus is connected to the cradle and confirms attendance based on identification information of the cradle transmitted from the cradle and the identification information of the mobile telephone.
